(19) United States
(12) Patent Application Publication
(10) Pub. No.: US 2007/0166446 A1
(43) Pub. Date: Jul. 19, 2007

(54) Method for producing a gluten-based baked product

(75) Inventor: Bernard Boursier, Violaines (FR)

Correspondence Address: YOUNG & THOMPSON, 745 SOUTH 23RD STREET, 2ND FLOOR, ARLINGTON, VA, 22202, US

(73) Assignee: ROQUETTE FRERES, LESTREM (FR)

(21) Appl. No.: 10/589,127

(22) PCT Filed: Feb. 9, 2005
(86) PCT No.: PCT/FR05/00288

§ 371 Date: Aug. 11, 2006

(30) Foreign Application Priority Data
Feb. 13, 2004 (FR) 0401470

(51) Int. Cl. A21D 10/00

(52) U.S. Cl. 426/549

(57) ABSTRACT

The invention relates to a method for producing a gluten-based baked product involving the following steps: forming a dough containing gluten, at least 15% water, an improving agent and, optionally, a leavening agent; kneading this dough; optionally permitting the dough to rise, and; baking the dough in order to obtain the baked product. The invention is characterized in that the dough to be baked comprises, with regard to the weight of the dough, 3 to 15% by weight of an improving agent selected from the group consisting of maltodextrins, pyrodextrins, polydextrose and oligosaccharides alone or mixed with one another, and 0.005 to 1% by weight of a reducing agent selected from the group consisting of cysteine, glutathione, deactivated dry yeast, bisulfite and proteases.

The present invention relates to a method for producing baked products containing gluten, employing a special improving agent. It relates in particular to all products containing gluten supplied as such or supplied by means of a flour, such as in particular raised-dough or proofed-dough bakery products, notably traditional French bread (baguettes), soft loaves, English loaves, brioches, bread rolls, pastries made with sweetened dough, cakes, pizza pastry, buns, frozen pastry, unraised pastries, textured products for human and animal nutrition.

To produce bread or bakery products, three components are required, whose action is complementary and inseparable: starch and gluten obtained from flour, and yeast. Wheat is the only cereal containing gluten, which has the following characteristic: when mixed with water, the flour will form an elastic mass that can be stretched. It is this ability that enables wheat flour to form dough that can be stretched out, shaped and baked to make various kinds of bread. The viscoelastic properties of gluten account for its importance in breadmaking. The gluten precursors are dispersed in the flour and extensive mechanical work of mixing is required to bring them together—this is the role of kneading. The purpose of the latter is to mix the ingredients, but above all to bind the gluten to give body to the dough. The flour used in breadmaking is a flour obtained from so-called breadmaking wheat. The breadmaking wheats have a relatively high protein content. Therefore they are mainly used for making bread, as they contain a sufficient proportion of gluten for producing a ball of dough having the desired shape and structure. The suitability of a wheat for bakery use is determined by the quantity and quality of the gluten.

There are three important properties of gluten in breadmaking. Firstly it must have good capacity for absorption of water. The ball of dough results from the mixing of flour and water. The proteins in the gluten will have to be able to absorb sufficient water to form the dough, and the latter must then offer enough resistance in the mixing process. The gluten must also display the property of being extensible. In a bread dough, during fermentation, i.e. while the dough rises, a reaction takes place after the leaven absorbs the sugars, and this absorption will produce carbon dioxide gas and alcohol. The gas produced within the dough will extend the gluten matrix, form gas bubbles and enable the dough to rise. If the gluten is not sufficiently elastic, the gas bubbles will burst and the dough will not rise.

The gluten must also display some resistance. It is this resistance that will permit the gas to remain in the dough until the cooking process establishes the structure of the dough. Without this resistance, the dough would collapse. A good-quality gluten requires a good balance between elasticity and extensibility.

If the physical properties of the flour are inadequate, improving agents are usually employed. Ascorbic acid is used most often, but also potassium bromate or an emulsifier such as the methyl esters of mono- and diglycerides of diacetyl tartaric acid (DATEM: diacetyl tartaric acid esters of monoglycerides) which act on the gluten network, reinforcing it, and/or extra gluten is added to the flour. Increasingly, there have been attempts to dispense with the use of chemical improving agents and especially ascorbic acid, but no appropriate solution has yet been found.

In view of the present state of the art, the applicant company set itself the goal of developing baked products containing gluten, without any of these problems connected with addition of chemical improving agents, and intends to offer products which can be made in the usual conditions or even in simplified conditions, without requiring the slightest complex operation, and which display satisfactory quality, equivalent or even superior to the products of the prior art.

After numerous tests, the applicant found that the goal defined above could be achieved provided it employed, starting from the stage of initial mixing of the ingredients, a special improving agent comprising maltodextrins, dextrins and/or oligosaccharides.

There is considerable prejudice concerning the use of dextrins or maltodextrins, especially in breadmaking. In fact, it was found that these had an adverse effect on the dough, which had poorer binding once they were added.

For this reason patent EP 0 463 935 B1 proposed adding indigestible dextrins to bread at a particular stage of the breadmaking process, i.e. once the dough had been kneaded to about 50% (a technique commonly called “sponge and dough” by a person skilled in the art) but the technological restrictions thus imposed on this addition mean there are certain constraints on production.

Addition of cellulose to indigestible dextrins is also known, as described in patent JP 2001-045960. The main purpose in adding cellulose is to absorb water from the dough so as to correct its texture, but the dough becomes extremely difficult to work. Furthermore, cellulose is a relatively expensive additive. The use of chicory flour, containing inulin and cellulose, as well as proteins and inorganic salts has also been described.

Patent application FR 2,822,643, owned by the applicant, proposed a bread containing 6.5 wt. % of branched maltodextrins, but production of this bread in good conditions could only be achieved after a certain mixing time and on making a paste of the maltodextrins in fat in order to obtain a correct gluten network. Moreover, forming the dough inevitably required a longer mixing time.

It appears that addition of polysaccharides of high molecular weight to bread, and more generally of edible fibers whether or not they are water-soluble, is accompanied by a certain number of problems, for solution of which a good many methods have been proposed already, but there are still difficulties, such as the need to provide a range of complex pretreatments, problems in handling as well as constraints imposed notably relating to in-process addition, in that no method is really completely satisfactory in solving the problems arising from the addition of edible fibers.

The present invention therefore relates to a method for producing a baked product comprising:
forming a dough comprising gluten, water, an improving agent and optionally a raising agent,
kneading this dough, optionally leaving the dough to rise,
baking the dough to obtain said baked product, characterized in that said baking dough contains from 0.1 to 3 wt. %, preferably from 0.5 to 2 wt. %, relative to the weight of the dough, of an improving agent selected from the group comprising maltodextrins, pyrodextrins, and oligosaccharides.

Quite unexpectedly, the applicant found that addition of this special improving agent right at the start of the process improved the rate of hydration of the gluten: in the presence of a small amount (i.e. in a proportion from 0.1 to 3 wt. % relative to the weight of the flour), the gluten undergoes hydration and binds very rapidly to form an elastic network. The present invention therefore specifically excludes the techniques using leaven (“sponge and dough”). The use of an agent for reinforcing the gluten network such as ascorbic acid in particular is no longer required and the network has better hydration and is well formed, and the processes occurring in the oven are such that the enzymes are no longer required.

Thus, depending on the formulas, it becomes possible, if required, to use so-called weak (low-gluten) flours and/or reduce the amount of gluten added and/or do without chemical improving agents (ascorbic acid, enzymes, emulsifiers) and the products have improved keeping qualities as well as better resistance to deep-freezing. This all therefore constitutes a very advantageous improvement over the prior art.

Above these proportions, i.e. above 3 wt. %, hydration of the gluten is spontaneous, the gluten undergoes agglutination instead of binding and it becomes necessary to make slight modifications to the formulas, i.e. reduce the proportion of gluten in the formula or work with low-gluten flours or use gluten reducing agents (bisulfite, cysteine, deactivated dried yeast, etc.) to lessen the cohesion of the gluten network. In certain cases it is also possible to use a slightly higher temperature of the water incorporated in the dough, which limits the agglutination of the gluten. At these doses, other very interesting properties appear: short kneading time, as well as short proving time, and products are obtained that display maximum softness. Above 15 wt. %, it is no longer possible to obtain a correct dough.

The invention therefore also relates to gluten-based baked products and the method of production thereof, containing 3 to 15 wt. %, relative to the weight of the dough, of an improving agent selected from the group comprising maltodextrins, pyrodextrins, polydextrose and oligosaccharides, alone or mixed together, and 0.005 to 1 wt. % of a reducing agent selected from the group comprising cysteine, glutathione, deactivated dried yeast, bisulfite and proteases. A person skilled in the art will of course adjust the dose of reducing agent in relation to the nature and the reducing activity of the agent selected.

The maltodextrins can comprise standard maltodextrins, such as the GLUCIDEX® maltodextrins marketed by the applicant.

According to a preferred variant of the present invention, branched maltodextrins will be used, such as those described in patent application EP 1,006,128, owned by the applicant. A further advantage of these branched maltodextrins is that they represent a source of indigestible fiber that is beneficial for the metabolism and for the intestinal equilibrium. In particular, branched maltodextrins with between 15 and 35% of 1-6-glycosidic bonds, a content of reducing sugars below 10%, a molecular weight Mw between 4000 and 6000 g/mol and a number-average molecular weight Mn between 2000 and 4000 g/mol can be used as improving agent. These branched maltodextrins are even more interesting according to the present invention because they do not alter the gelatinization temperature of starch, and therefore the viscosity of the doughs is not increased. Moreover, absorption of water does not change when said maltodextrins are added.

Certain sub-families of branched maltodextrins described in said application can also be used in accordance with the invention. This applies in particular to branched maltodextrins of low molecular weight with a content of reducing sugars between 5 and 20% and a molecular weight Mn below 2000 g/mol.

These maltodextrins can of course be used alone or mixed with other improving agents according to the invention.

The pyrodextrins are products obtained by heating starch at low water content, in the presence of acid or basic catalysts, and generally having a molecular weight between 1000 and 6000 dalton. This dry roasting of starch, most commonly in the presence of acid, leads both to depolymerization of the starch and rearrangement of the starch fragments obtained, leading to the formation of very branched molecules. This definition applies in particular to the so-called indigestible dextrins, with an average molecular weight of the order of 2000 dalton.

“Oligosaccharides” notably means the galacto-oligosaccharides, fructo-oligosaccharides and oligofructose, gum arabic, resistant starches, pea fibers. Preferably, the dough according to the invention does not contain additional cellulose.

The baked products according to the invention designate articles made appropriately by cooking, for example in an oven, in water, by extrusion baking, of doughs prepared by kneading a starting flour and water, to which other additives commonly used can be added as required, notably yeast, salt, sugars, sweeteners, dairy products, fats, emulsifiers, spices, dried fruit, flavourings, amylolytic enzymes. The dough used in the production of the baked products according to the invention preferably contains more than 15 wt. % of water.

According to an advantageous variant of the invention, the dough does not contain fat, since the improving agent according to the invention has the additional advantage that it partially or completely replaces the fats commonly used. Moreover, when we try to make low-fat products, the products generally suffer a loss of softness, as is the case with brioches in particular. Use of the improving agent according to and in the conditions of the present invention offers the advantage of compensating the loss of softness of a product with lower fat content, using little if any supplementary additives.

The “starting flour” generally denotes wheat flours, which can be supplemented with or partially replaced by rye, maize and rice flour in particular. “Wheat flours” means traditional milled flours, from white flour to wholewheat flour.

The invention applies without distinction to all varieties of dough, whether or not it is proofed dough or raised dough. The products obtained from raised doughs are for example bread, special bread, Viennese bread, brioches, pizzas, rolls for hamburgers. The products obtained from proofed doughs are for example biscuits, cookies, muffins, fruit cake and other cakes, and products based on puff-pastry. The unraised doughs are in particular pasta (spaghetti, tagliatelle, macaroni, noodles, and others) in all its forms, made from hard or soft wheat flour. The invention also applies to extruded products such as snacks, breakfast cereals, crackers, and any textured product containing gluten.

The invention also relates to the use of an improving agent selected from the group comprising maltodextrins, pyrodextrins and oligosaccharides for improving the viscoelastic index of the gluten. In fact, when using the improving agent according to the invention, the gluten is more cohesive in the recommended proportions, i.e. between 0.1 and 3 wt. % relative to the weight of the flour.

The invention will be better understood on reading the following examples and the diagram relating to them, which are intended for illustration and are non-limiting.

### EXAMPLE 1

### Improvements to the Viscoelastic Properties of Gluten, Production of Bread

Loaves are made according to a formula for French bread based on Leforest wheat flour with the following analysis:
water content 15.6%
proteins 10.7%
alveogram P78, W272, P/L 0.71

The dough is kneaded using an inclined-shaft kneading machine, 5 minutes speed 1, then 12 minutes speed 2, and 5 minutes speed 2 with salt.

Proofing is carried out at 24° C. in an atmosphere with 75% humidity.

Baking is carried out for 24 minutes at 240° C.

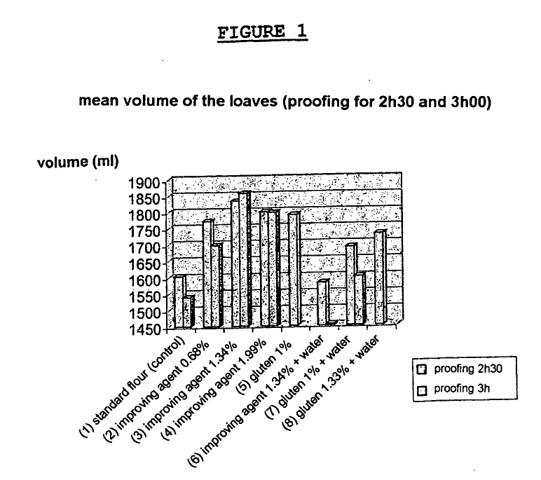

Evaluation is based on the following tests:
For the dough: the length in cm of the ball of dough after lengthening on the shaper provides information on dough tenacity.
For the bread: after proofing for 2 h30 and 3 h00, the balls of dough are baked. The volumes of the loaves after proofing for 2 h30 and of the loaves after proofing for 3h00 are measured in a volumeter: the mean volume is given in ml (see FIG. 1).

The tests were conducted relative to a standard flour, in the following way:
Doughs at 60% hydration (tests 1 to 6), formulas with 0.68-1.34-1.99% of branched maltodextrins compared with a formula with 1.00% of gluten (percentage calculated on a finished product at 62.7% dry matter).

Doughs at 61% hydration (tests 5, 7, 8), formula with 1.34% of branched maltodextrins compared with formulas with 1.00 and 1.33% of gluten.

| | Test 1 | Test 2 | | Test 3 | | Test 4 | Test 6 |
|---|---|---|---|---|---|---|---|
| Leforest flour (g) | 1000 | 1000 | | 1000 | | 1000 | 1000 |
| Vital gluten (g) | 0 | 0 | | 0 | | 0 | 15 (1%) |
| Branched | 0 | 10 (0.68%) | | 20 (1.34%) | | 30 (1.99%) | 0 |
| maltodextrins (g) | | | | | | | |
| Water (g) | 600 | 600 | | 600 | | 600 | 600 |
| Yeast (g) | 22 | 22 | | 22 | | 22 | 22 |
| Salt (g) | 22 | 22 | | 22 | | 22 | 22 |
| Ascorbic acid 1% | 2 | 2 | | 2 | | 2 | 2 |
| (ml) | | | | | | | |
| Enzyme (g) | 0.05 | 0.05 | | 0.05 | | 0.05 | 0.05 |
| T° C. end of | 24.8 | 26 | | 25.3 | | 26 | 25.5 |
| kneading | | | | | | | |
| Elongation in | 33.27 | 32.16 | | 31.38 | | 31.44 | 32.33 |
| shaping (cm) | | | | | | | |
| Proofing 2 h 30 | 1604 ml | 1772 | ml | 1834 | ml | 1800 ml | 1582 ml |
| mean volume | | | | | | | |
| Proofing 3 h 00 | 1540 ml | 1697.5 | ml | 1857.5 | ml | 1797 ml | 1455 ml |
| mean volume | | | | | | | |

| | Test 5 | Test 7 | Test 8 |
|---|---|---|---|
| Leforest flour (g) | 1000 | 1000 | 1000 |
| Vital gluten (g) | 0 | 15 (1%) | 20 (1.33%) |
| Branched | 20 (1.34%) | 0 | 0 |
| maltodextrins (g) | | | |
| Water (g) | 630 | 630 | 630 |
| Yeast (g) | 22 | 22 | 22 |
| Salt (g) | 22 | 22 | 22 |
| Ascorbic acid 1% | 2 | 2 | 2 |
| (ml) | | | |
| Enzyme (g) | 0.05 | 0.05 | 0.05 |
| T° C. end of | 25.5 | 25.5 | 25.3 |
| kneading | | | |
| Elongation in | 32.33 | 32 | 32.77 |
| shaping (cm) | | | |
| Proofing 2 h 30 | 1790 ml | 1690 ml | 1730 ml |
| mean volume | | | |
| Proofing 3 h 00 | nd | 1600 ml | nd |
| mean volume | | | |

Standard Flour No. 1, Tests 2, 3 and 4

The improving agent according to the invention increases the tenacity of the doughs with a maximum (in the chosen conditions of hydration) at 1.34 or 1.99%; the volumes of the loaves after proofing for 2 h30 increase from 1600 to 1800 ml on adding 0.68% of branched maltodextrins; the volumes of the loaves with 1.34% of branched maltodextrins do not decrease after proofing for 3 h00.

Greater hydration in a dough containing 1.34% of improving agent according to the invention makes the dough flexible and does not permit the volume of the loaves to be increased (tests 3 and 5).

Standard Flour No. 1, Tests 6, 7 and 8

Gluten increases the tenacity of the doughs and increases loaf volume but at higher concentrations than those used for the branched maltodextrins. An increase in hydration of the dough enables the gluten to fulfill its role completely and increase loaf volume; the volumes of the loaves with 0.68% of branched maltodextrins (dough with 60% water, test 2) are equivalent to those of the loaves with 1.33% of gluten (dough with 61% water, test 8) (see FIG. 1).

Other improving agents according to the invention were tested: oligofructose, standard maltodextrins GLUCIDEX® 2 and GLUCIDEX® 28.

The behavior of oligofructose is equivalent to that of the other improving agents. The maltodextrins reduce the tenacity of the dough and increase the volumes of the loaves but to a more limited extent than the branched maltodextrins or oligofructose.

Conclusions: The improving agents according to the invention have the following effects: At a dose of 0.68% based on the finished product, they endow the doughs with tenacity and increase the volume of the loaves by more than 10%. These effects increase with the concentration of improving agent up to a maximum effect of volume increase of 14% for a dose of 1.34% in our operating conditions. The degree of hydration of the dough is not increased.

With gluten, the effects are identical but the degree of hydration must be increased and a larger amount of gluten is required to obtain identical effects: volumes of loaves with 0.68% of branched maltodextrins and 60% hydration equivalent to the volumes of loaves with 1.33% gluten and 61% hydration.

### EXAMPLE 2

### Production of Brioches

Brioches are produced, employing an improving agent according to the invention selected from:
standard maltodextrins (GLUCIDEX® 1, 2 or 6)

branched maltodextrins, oligofructose, Raftilose®

| | | | B | | C | |
|---|---|---|---|---|---|---|
| | | | 5% improving | | 10% improving | |
| | A | | agent according | | agent according | |
| | Control | | to the invention | | to the invention | |
| Leforest flour (g) | 1009.9 | | 1014.7 | | 984.8 | |
| Vital gluten (g) | 40 | | 40 | | 40 | |
| Méliose glucose syrup (g) | 175 | | 175 | | 85 | |
| Whole egg 4° C. (g) | 150 | | 150 | | 150 | |
| Fresh butter 85 wt. % (g) | 300 | | 200 | | 200 | |
| Water (g) | 250 | | 250 | | 270 | |
| Improving agent according | 0 | | 100 | | 200 | |
| to the invention (g) | | | | | | |
| Baker's yeast (g) | 50 | | 50 | | 50 | |
| Salt (g) | 20 | | 20 | | 20 | |
| Enzyme (g) | 0.1 | | 0.1 | | 0 | |
| Ascorbic acid 1% (ml) | 5 | | 0 | | 0 | |
| Cysteine (g) | 0 | | 0.2 | | 0.2 | |
| Total (g) | 2000 | | 2000 | | 2000 | |
| Water temperature | 8° | C. | 25° | C. | 30° | C. |
| Spiral kneader Speed 1 | 3 | min | 1 | min | 1 | min |
| Spiral kneader Speed 2 | 15 | min | 8 | min | 15 | min |
| Temperature at end of | 29.5° | C. | 26.5° | C. | 27° | C. |
| kneading | | | | | | |
| Relaxation time at room | 15 | min | 15 | min | 15 | min |
| temperature | | | | | | |

| | | | |
|---|---|---|---|
| Proofing time 28° C., 85% | 1 h 45 | 1 h 45 | 1 h 45 |
| H2O | | | |

Weighing and rolling of 500 g brioches and 60 g briochettes

| | | | | | | |
|---|---|---|---|---|---|---|
| Length increase in | 36.7 | cm | 32.9 | cm | 32.9 | cm |
| shaping of the | | | | | | |
| brioches 4/3 | | | | | | |

The briochettes are shaped by hand
Baking in rotary oven 190° C., brioches 23 minutes, briochettes 15 minutes. Egg and water
glaze.

| | | | | | | |
|---|---|---|---|---|---|---|
| Average weight of | 465.3 | g | 465 | g | 463 | g |
| brioche after baking | | | | | | |
| Average weight of | 53.4 | g | | | 52.77 | g |
| briochette after baking | | | | | | |
| Average volume of | 1747 | ml | 1707 | ml | 1970 | ml |
| brioche | | | | | | |
| Volume of 3 briochettes | 560 | ml | 540 | ml | 740 | ml |

| | | | |
|---|---|---|---|
| Final moisture content | 31.99% | 31.12% | 29.45% |
| of brioche | | | |

According to the standard formula for production of brioches in the prior art, important constraints appear, such as the need to make a paste of the fat and maltodextrins prior to incorporation in the dough, and a considerable increase in mixing time (from 15 minutes to 45 minutes with incorporation of maltodextrins). Furthermore it is essential to add ascorbic acid to the dough.

For production of brioches without the aforementioned drawbacks, according to the invention it is necessary to:
reduce the amount of maltodextrins to a content between 0.1 and 3 wt. % relative to the weight of flour, which in this case makes it possible to reduce the amount of gluten added
or maintain an amount above 3%, but removing the gluten from the recipe, or raising the temperature of the hydration water or adding cysteine (0.2 parts by weight) to improve the formation of the dough, and then maximum softness is obtained.
   Results:

The improving agents according to the invention have similar effects of increase in dough tenacity and improvement of the volume of the finished products, though the results obtained with oligofructose are poorer than the others. Softness is judged to be superior to the control when the dose of improving agent is greater than 5%.

The standard maltodextrins increase the extensibility of the dough and the volume of the brioches. They have less pronounced effects on dough tenacity than the other improving agents. There is also an appreciable increase in volume, but softness is somewhat less developed.

Ascorbic acid can be left out, as can the enzymes.

### EXAMPLE 3

### Production of Hamburger Rolls without Added Sugar

A-Formula

| | Ingredients | Composition % of |
|---|---|---|
| | by weight | finished product |
| Wheat flour (10.5% proteins) | 100.00 | 26.46 |
| Vital wheat gluten VITEN ® | 38.07 | 10.76 |
| Branched maltodextrins according | 34.52 | 9.86 |
| to the invention | | |
| Devitalized wheat gluten | 10.15 | 2.87 |
| DEVITEN | | |
| Pressed yeast | 6.09 | 0.53 |
| Acesulfam K | 0.08 | 0.02 |
| Salt | 3.05 | 0.92 |
| Reducing agent (cysteine) | 0.10 | 0.03 |
| Water at 30° C. | 90.66 | 46.00 |
| Butter | 9.14 | 2.31 |
| Emulsifier (including DATEM) | 0.81 | 0.24 |

B-Method
Dissolve the cysteine in the water at 30° C.
Mix together the powders, add water.
Mix in the spiral kneader 30 seconds speed 1 then 7 minutes speed 2 (final temperature 32° C.).
Leave to rest for 15 minutes.
Cut off 60-g pieces, roll into a ball, flatten and mold.
Ferment at 40° C., 95% RH for 60 minutes.
Bake in the oven at 205° C. for 11 minutes.

Rolls are obtained with organoleptic characteristics comparable to the products of the prior art according to a simple process. The calorific value of the rolls, found by calculation, is 209.40 kcal/100 g.

### EXAMPLE 4

### Production of Hamburger Rolls without Added Fats and without Added Sugar

A-Formula

| | Ingredients | Composition % of |
|---|---|---|
| | by weight | finished product |
| Wheat flour (10.5% proteins) | 100.00 | 27.77 |
| Vital wheat gluten VITEN ® | 38.07 | 11.29 |
| Branched maltodextrins according | 34.52 | 10.35 |
| to the invention | | |
| Devitalized wheat gluten | 10.15 | 3.01 |
| DEVITEN | | |
| Pressed yeast | 6.09 | 0.56 |
| Acesulfam K | 0.08 | 0.03 |
| Salt | 3.05 | 0.96 |
| Reducing agent (cysteine) | 0.10 | 0.03 |
| Water at 30° C. | 90.68 | 46.00 |

B-Method
Dissolve the cysteine in the water at 30° C.
Mix together the powders, add water.
Mix in the spiral kneader 30 seconds speed 1 then 7 minutes speed 2 (final temperature 32° C.).
Leave to rest for 15 minutes.
Cut off 60-g pieces, roll into a ball, flatten and mold.
Ferment at 40° C., 95% RH for 60 minutes.
Bake in the oven at 205° C. for 11 minutes.

Use of the improving agent according to the invention in a dough with high water content, in the presence of a reducing agent, means advantageously that the fats can be omitted from the formula, but compensates for the loss of softness due to the absence of the fats.

It is then possible to formulate bread rolls for hamburgers of lower calorific value than rolls containing fat, but maintaining satisfactory organoleptic characteristics. The calorific value found by calculation is 199.56 kcal/100 g, against 209.40 kcal/100 g according to the formula in Example 3.

### EXAMPLE 5

### Production of French Bread According to the Invention

A-Formula

| | Ingredients | Composition % of |
|---|---|---|
| | by weight | finished product |
| Wheat flour (10.5% proteins) | 100.00 | 53.19 |
| Vital wheat gluten VITEN ® | 4.17 | 2.42 |
| Branched maltodextrins | 6.67 | 9.79 |
| Pressed yeast | 2.29 | 0.35 |
| Salt | 2.29 | 1.42 |
| Cysteine | 0.014 | 0.009 |
| Water at 25° C. | 60.42 | 32.82 |

B-Method
Dissolve the cysteine in the water at 30° C.
Mix together the powders, add water.
Mix in the spiral kneader 30 seconds speed 1 then 8 minutes speed 2 (final temperature 26° C.).
Leave to rest for 10 minutes.
Weigh 100-g pieces, roll into a ball.
Shape.
Ferment at 25° C., 75% RH for 1 h 45 minutes.
Bake in the oven at 215° C. for 13 minutes.

In accordance with the invention, French bread of very satisfactory quality is obtained, without addition of ascorbic acid.

### EXAMPLE 6

### Production of Biscuits According to the Invention

Biscuits are produced according to the invention using the formulas given below, employing branched maltodextrins of various molecular weights, hydrogenated or unhydrogenated, and polydextrose (Litesse® Ultra) as improving agent, in combination with pea fiber.

| Proportions by | | | | | |
|---|---|---|---|---|---|
| weight | Test 1 | Test 2 | Test 3 | Test 4 | Test 5 |
| Leforest flour | 485.5 | 485.5 | 485.5 | 485.5 | 485.5 |
| Pea fiber | 60 | 60 | 60 | 60 | 60 |
| Improving agent | 71 | 71 | 71 | 71 | 71 |
| Vegetable fat | 89 | 89 | 89 | 89 | 89 |
| Maltisorb ® P200 | 186 | 186 | 186 | 186 | 186 |
| Lametop 300 | 6 | 6 | 6 | 6 | 6 |
| DATEM | | | | | |
| Sodium bicarbonate | 2.4 | 2.4 | 2.4 | 2.4 | 2.4 |
| Ammonium | 3.6 | 3.6 | 3.6 | 3.6 | 3.6 |
| bicarbonate | | | | | |
| Sodium | 1.5 | 1.5 | 1.5 | 1.5 | 1.5 |
| pyrophosphate | | | | | |
| Vanilla flavor | 2 | 2 | 2 | 2 | 2 |
| (Mane) | | | | | |
| Butter flavor | 1 | 1 | 1 | 1 | 1 |
| (Mane) | | | | | |
| Salt | 2 | 2 | 2 | 2 | 2 |
| Water | 110 | 110 | 110 | 110 | 95 |
| Total | 1020 | 1020 | 1020 | 1020 | 1005 |
| Baking in rotary | 9 min | 9 min | 9 min | 9 min | 9 min |
| oven 200° C. | | | | | |
| Hardness of biscuit | 10 | 12.5 | 10 | 11.2 | 9.8 |
| (N) | | | | | |
| Softness and | + | ++ | + | + | ++ |
| crunchiness of | | | | | |
| the biscuit | | | | | |

Test 1: branched maltodextrin of molecular weight Mw = 5000 and Mn = 2650.
Test 2: branched maltodextrin of molecular weight Mw = 3820 and Mn = 1110.
Test 3: branched maltodextrin of molecular weight Mw = 2125 and Mn = 600.
Test 4: refined polydextrose (Litesse ® Ultra).
Test 5: maltodextrin from test 1, hydrogenated.

Use of up to 7% of pea fiber makes the biscuit softer and more friable, and compensates for the reduction in fats.

All the biscuits have equivalent organoleptic characteristics, but the biscuit in test 3 is preferred as it is slightly more crunchy.

### EXAMPLE 7

### Production of Low-calorie Loaves According to the Invention

Low-calorie loaves according to the invention are produced with the formulas shown below, which use branched maltodextrins or polydextrose (Litesse® Ultra) as the improving agent.

| | | |
|---|---|---|
| Proportions by weight | Test 1 | Test 2 |

| Leforest flour | 530 | | 530 | |
|---|---|---|---|---|
| Vital gluten | 400 | | 400 | |
| Improving agent | 300 | | 300 | |
| Devitalized gluten | 300 | | 300 | |
| Soy oil | 100 | | 100 | |
| Guar gum | 25 | | 25 | |
| Pressed yeast | 55 | | 55 | |
| Salt | 30 | | 30 | |
| Ascorbic acid | 0.2 | | 0.2 | |
| Enzyme | 0.2 | | 0.2 | |
| Water at 30° C. | 920 | | 920 | |
| Cysteine, Nutrilife MCY | 1.4 | | 1.4 | |
| Total | 2661.8 | | 2661.8 | |
| Spiral kneader Speed 1 | 9 | min | 9 | min |
| Spiral kneader Speed 2 | 10 | | 12.5 | |
| Temperature at end of kneading | 36.2° | C. | 36.8° | C. |

Test 1: branched maltodextrin of molecular weight Mw = 5000 and Mn = 2650.
Test 2: refined polydextrose (Litesse ® Ultra).

On completion of kneading, divide into 500-gram pieces, roll into a ball, pass immediately to the shaper, place in greased molds, and put in the proofing chamber, at 35° C., 80% relative humidity, for 60-90 minutes.

Then bake the loaves in the rotary oven at 220° C.

Results: when used at concentrations above 3%, the improving agents according to the invention cause effects of splitting of the dough, which can be corrected by using a reducing agent such as cysteine. The proofing times are longer when polydextrose is used (reduced swelling volume).

1. A method for producing a baked product comprising:
forming a dough containing gluten, at least 15% of water, an improving agent and optionally a raising agent,
kneading this dough,
optionally leaving the dough to rise,
baking the dough to obtain said baked product, characterized in that said baking dough contains from 3 to 15 wt. %, relative to the weight of the dough, of an improving agent selected from the group comprising maltodextrins, pyrodextrins, polydextrose and oligosaccharides alone or mixed together, and 0.005 to 1 wt. % of a reducing agent selected from the group comprising cysteine, glutathione, deactivated dried yeast, bisulfite and proteases.

2. The method as claimed in claim 1, characterized in that said dough does not contain additional cellulose.

3. The method as claimed in claim 1, characterized in that said improving agent comprises branched maltodextrins having between 15 and 35% of 1-6-glycosidic bonds, a content of reducing sugars below 10%, a molecular weight Mw between 4000 and 6000 g/mol and a number-average molecular weight between 2000 and 4000 g/mol.

4. A baked product containing gluten, 3 to 15 wt. % of
an improving agent selected from the group comprising maltodextrins, pyrodextrins, polydextrose and oligosaccharides alone or mixed together, and 0.005 to 1 wt. % of a reducing agent selected from the group comprising cysteine, glutathione, deactivated dried yeast, bisulfite and proteases.

5. A baked product as claimed in claim 4,
characterized in that it is a brioche or a hamburger roll.

6. The method as claimed in claim 2, characterized in that said improving agent comprises branched maltodextrins having between 15 and 35% of 1-6-glycosidic bonds, a content of reducing sugars below 10%, a molecular weight Mw between 4000 and 6000 g/mol and a number-average molecular weight between 2000 and 4000 g/mol.
